(19) United States
(12) Patent Application Publication
(10) Pub. No.: US 2013/0309366 A1
(43) Pub. Date: Nov. 21, 2013

(54) SOFTGEL CAPSULES WITH IRIDESCENT APPEARANCE AND CONTAINING DIETARY SUPPLEMENT

(71) Applicant: Lang Pharma Nutrition, Inc., Newport, RI (US)

(72) Inventor: David P. Lang, Portsmouth, RI (US)

(73) Assignee: Lang Pharma Nutrition, Inc., Newport, RI (US)

(21) Appl. No.: 13/896,086

(22) Filed: May 16, 2013

Related U.S. Application Data
(60) Provisional application No. 61/648,063, filed on May 16, 2012.

(51) Int. Cl. A23L 1/275

(52) U.S. Cl. CPC A23L 1/2751
USPC 426/89; 426/250; 426/138

(57) ABSTRACT

The invention pertains to softgel capsules that have an iridescent appearance and contain one or more dietary supplements and to their methods of manufacture. The softgel capsule comprises a shell for containing one or more dietary supplements, the shell comprised of a gelatinized gelatin and an iridescent mica-based mineral pigment that imparts an iridescent appearance to the shell; and one or more dietary supplements contained within the shell. Iridescent mica-based pigments are incorporated into a gelatin softgel capsule in a unique formulation.

This application claims the benefit of earlier filed U.S. Provisional Application No. 61/648,063, filed on May 16, 2012, which is hereby incorporated by reference herein.

### FIELD OF THE INVENTION

A softgel capsule having an iridescent or pearlescent appearance as observed by the user, optionally containing a dietary supplement formulation. Mica-based pigments are incorporated into a gelatin softgel capsule in a unique formulation.

### BACKGROUND

Most dietary supplements are swallowed and are in capsule or tablet form. Those that are oil-based are nearly always in a softgel capsule. Most softgel capsules are made from bovine or porcine gelatin, although some are vegetarian-based (e.g., vegetable glycerine). Some other capsules are also made from fish gelatin, such as tilapia. The color of the softgels is often golden-yellow, due to the gelatin itself, and if it contains a marine oil, that, too, is usually, but not always, yellowish (krill oil is deep red, for example, and thus when in a softgel capsule, it appears as that red color). Other dietary supplements, which are non-oil-based, can also be added to a softgel capsules, but this is less common.

Transparent, translucent and opaque softgels are known. However, in view of advances in mica-containing pigments, it would be advantageous to obtain softgel capsules that reflect and/or refract light.

If a way could be found to incorporate such refractive mica-containing pigments within the softgel structure while also encapsulating certain dietary supplements, this would represent a valuable contribution to the art.

### SUMMARY OF THE INVENTION

The invention pertains to softgel capsules that have an iridescent appearance and contain one or more components included in dietary supplements. The softgel capsule comprises or consists of a shell for housing one or more dietary supplements, the shell comprised of a gelatinized gelatin and an iridescent mineral pigment that imparts an iridescent appearance to the shell; and one or more dietary supplements contained within the iridescent shell. In one embodiment, the iridescent mineral pigment is incorporated into the gelatin prior to gelatinization. In another embodiment, the iridescent mineral pigment is coated on the surface of the shell. Preferably, the softgel capsule will be round and of a size that is easy to swallow.

Also described herein are methods for making the softgel capsules of the invention. In one embodiment, the softgel capsule having an iridescent appearance is produced by a process comprising: a) incorporating an iridescent mineral pigment into a gelatin composition; b) gelatinizing the gelatin composition of step (a) to thereby form an iridescent shell suitable for containing or housing one or more dietary supplements and having an iridescent appearance; and c) adding the one or more dietary supplements into the iridescent shell to produce a softgel capsule. Preferably, the softgel capsule will be round and of a size that is easy to swallow.

In another embodiment, the softgel capsule having an iridescent appearance is produced by a method comprising: a) gelatinizing a gelatin composition to thereby form a shell suitable for containing or housing one or more dietary supplements; b) incorporating the one or more dietary supplements into the shell to produce a softgel capsule; and c) coating the softgel capsule with an iridescent mineral pigment to impart an iridescent appearance. Preferably, the softgel capsule will be round and of a size that is easy to swallow.

### DETAILED DESCRIPTION

The invention pertains to softgel capsules that have an iridescent appearance and contain one or more dietary supplements. The term “iridescent appearance” as used herein is intended to mean having an appearance of luminous colors that seem to change or shift when observed from different angles. Luminous colors can be nacreous (lustrous and pearly) or opalescent and will depend upon the type of mineral present in the pigment. For example, a white-pearl like pigment will have a white background color that is opaque and contain iridescent colors that can swirl, move or glitter as the light reflects off the surface of the softgel capsule, as observed by a human eye.

Known softgel encapsulated products include transparent, translucent, and opaque versions. Normally, the materials added to a gelatin shell, in addition to providing a shell color, will create either an opaque or translucent shell. Moreover, chemical additives are typically soluble in the gelatin blend or matrix used to create a shell color. For example, one can add titanium dioxide to a solid material in order to eliminate translucence. In the present disclosure, it may be desirable to partially hide or visually cover the contents of a translucent softgel, but this can be difficult to achieve using titanium dioxide alone. A better solution was needed.

The present inventor has discovered that when pearlescent or iridescent pigments are incorporated into the gelatin matrix before gelation, the final shell product exhibits refraction in addition to reflection, and translucency is mitigated to produce pleasing and useful color combinations in softgel capsules filled with one or more components in a dietary supplement. Due to the refractive characteristics observed in the softgel embodiments prepared herein, the products are not merely opaque nor merely reflective, but rather the different colors of the shell and fill materials blend together in a unique color system that can be fined tuned as needed.

By using the ratios as exemplified, a skilled formulator can prepare a softgel capsule with desired colors or iridescent color patterns that “fool the human eye” by refracting light. The ratios of the gelatin, glycerin, water, and pigment have been experimentally determined for maximum flexibility in formulating filled softgel capsules having the desired color characteristics. The examples below demonstrate the flexibility and versatility of the method, and how one might tailor either pearlescent (or “pearlized”) softgel shells or pearlescent filled softgel capsules.

The softgel capsules of the invention can house or contain any type of dietary supplement in addition to oils and further can house one or a combination of dietary supplements depending upon the intended purpose of the capsule. In certain embodiments the invention provides a unique assembly of components in the form of a softgel having an iridescent appearance and containing any suitable dietary supplement for oral ingestion, preferably by swallowing only. The invention provides a new way of delivering dietary supplements to an individual, as conventional softgel capsules do not have an iridescent appearance as described herein.

Details of one exemplary embodiment of the invention compared to existing commercial softgel capsules are summarized in Table 1.

TABLE 1

| | Existing Soft-Gel | |
|---|---|---|
| Attribute | Capsules | An Embodiment |
| Use | Based on the dietary | Same |
| | supplement in it | |
| Capsule shape | Oval | Round, spherical |
| Color | Usually yellowish | Luminescent, mineral |
| | | pigment of any color. For |
| | | example, the color can be a |
| | | white-pearl color. The use |
| | | of iridescent, mineral |
| | | pigments produces |
| | | iridescent, pearl-like |
| | | opaque colored finishes |
| | | regardless of color. |
| Soft-gel material | Bovine gelatin, | Same |
| | porcine gelatin, | |
| | fish gelatin, | |
| | vegetarian sources. | |
| Dietary supplement | Typically softgels | Used for all dietary |
| added to capsule | are used for oils | supplements including |
| | from the sea or | natural oils |
| | plants | |
| Process | Standard, known to | Incorporation of iridescent |
| | those familiar with | pigments directly into |
| | making such capsules | gelatin shell |
| | and adding coloring | |
| Means of ingestion | Swallowed | Same |

Dietary supplements. Exemplary dietary supplements included in the softgel capsules of the invention are present in amounts that are typically commercially available. Some examples of dietary supplements to be included in the capsules, include but are not limited to, vitamins (e.g., vitamin D, vitamin C, folic acid, biotin), minerals (e.g., calcium, zinc, potassium), inositol, trace elements (e.g., chromium), herbs, plant extracts, and other botanicals (e.g., quercetin, Echinacea, astragalus, goldenseal, ginseng), any combinations of these and any other compounds classified as a dietary supplement (e.g., methylsulfonylmethane [MSM], CoQ10, resveratrol, astaxanthin, melatonin, tryptophan, lutein, genistein).

The softgel capsules of the invention may further contain additional components such as proteins or amino acids, carbohydrates, lipids, vitamins, minerals and cofactors, natural or artificial flavors, dyes or other coloring additives, and preservatives. The term “vitamins” includes, but is not limited to, thiamine (e.g., thiamine mononitrate), riboflavin (vitamin B2), nicotinic acid, panthothenic acid, pyridoxine, vitamin B6 (e.g., pyridoxine HCl), biotin, folic acid, vitamin B12 (e.g, cyanocobalamin), lipoic acid, ascorbic acid, vitamin A, vitamin C (e.g., ascorbic acid), vitamin D (e.g., cholecalciferol), vitamin E (e.g., di-alpha tocopheryl acetate), and vitamin K (e.g., phytonadione), niacin (e.g., niacinamide), vitamin B5 (e.g., d-calcium pantothenate). Also included within the term “vitamins” are cofactors and coenzymes including, but not limited to, thiamine pyrophosphates (TPP), flavin mononucleotide (FMM), flavin adenine dinucleotide (FAD), nicotinamide adenine dinucleotide (NAD), nicotinamide adenine dinucleotide phosphate (NADP), Coenzyme A (CoA), pyridoxal phosphate, biocytin, tetrahydrofolic acid, coenzyme B12, lipoyllysine, 11-cis-retinal, and 1,25-dihydroxycholecalciferol. The term “vitamins” also includes choline, carnitine, and alpha, beta, and gamma carotenes. The term “minerals” refers to inorganic substances, metals, and the like, required in the human diet, including, but not limited to, calcium (e.g., calcium carbonate), iron (e.g., ferrous fumarate), zinc (e.g., zinc oxide), selenium (e.g., sodium selenite), copper (e.g., copper sulfate), iodine, magnesium (e.g., magnesium oxide), phosphorus, chromium (e.g., chromium picolinate), manganese (e.g., manganese sulfate), potassium (e.g., potassium iodide), Boron (e.g., boron amino acid chelate), Molybdenum (e.g., sodium molybdate) and the like, and mixtures thereof. The mineral may be in the form of a salt, an oxide, or a chelated salt.

The softgels can also contain fruit and/or vegetable extracts or concentrates such as but not limited to pomegranate, acai, grape, plum, cranberry, blueberry, strawberry, blackberry, bilberry, cherry, apricot, papaya, orange, pineapple, parsley, kale, spinach, wheat grass, brussel sprouts, asparagus, broccoli, cauliflower, beet, carrot, cabbage, garlic, and the like.

Flavors incorporated in the softgel capsules may be chosen from synthetic flavor oils and flavoring aromatics and/or natural oils, extracts from plants, leaves, flowers, and fruits, and combinations thereof. These may include, but are not limited to, cinnamon oil, oil of wintergreen, peppermint oils, clove oil, bay oil, anise oil, eucalyptus, thyme oil, cedar leaf oil, oil of nutmeg, oil of sage, oils of citrus fruits (including, but not limited to, lemon and orange), oil of bitter almonds, and cassia oil. Suitable flavors include, but are not limited to, vanilla, chocolate, mocha, coffee, ice cream, citrus (including lemon, orange, grape, lime, and grapefruit), apple, pear, peach, mango, strawberry, raspberry, cherry, plum, pineapple, and apricot. The amount of flavoring may depend on a number of factors, including the organoleptic effect desired. Flavors may be present in an amount up to about 2% by weight (based on the dietary supplement composition or fill), preferably ranging from about 0.25% by weight to about 2% by weight based on the total weight of the formulation, with the average between about 0.5% by weight to about 1% by weight based on the total weight of the formulation. about 0% to about 2% by weight; from about 0.25% to about 2%; from about 0.5 to about 0.75 by weight.

Suitable oils for incorporation into a softgel capsule in an embodiment of the invention, includes but are not limited to, an edible oil, extracts, and oil concentrations selected from fish oil or fish oil extracts or concentrates (including without limitation oils, extracts and concentrations of menhaden, anchovy, anchoveta, hake, salmon, tuna, pollock, whiting, cod, catfish, flounder, grouper, halibut, mahi mahi, orange roughy, red snapper, shark, swordfish, tilefish, king mackerel, and mixtures thereof), krill oil, seal oil, borage oil, flax seed oil, evening primrose oil, soybean oil, hemp seed oil, pumpkin seed oil, grape seed oil, germ oil, safflower oil, squalene oil, squalane, sesame seed oil, arachidonic acid, conjugated linoleic acid, rosemary oil, lemon oil, peppermint oil, terrapin oil, pomegranate seed oil, sea buckthorn fruit oil, sunflower oil, chia oil, goji berry oil, sea buckthorn oil, jasmine oil, sweet almond oil, ginger oil, parsley seed oil, orange oil, halibut liver oil, wheat germ oil, aloe vera oil, garlic oil, avocado oil, castor oil, saw palmetto extract oil, olive oil, mineral oil, median chain tryglycerin, lavender oil, phosphatidylipids, rice bran oil, macadamia nut oil, arachis oil, phytosterol, phytotanol, or combinations, blends, or mixtures thereof.

Softgels. The softgel capsules in certain embodiments can be made from animal-derived gelatin, such as but not limited to bovine gelatin, porcine gelatin, fish gelatin, and plant-derived sources, such as potato starch and carrageenan. The shape and size of the softgel can vary depending upon the amount of dietary supplement incorporated therein, and the age of the individual intended to take the softgel capsule. In a preferred embodiment, the softgel capsule will be oval or round, in two-dimensional space, corresponding to oblong or spheroidal shape in three-dimensional space, respectively. Most preferably, the softgel capsule will be round or spheroidal. A preferred softgel capsule size is number 7, which has a dimension of approximately 5.0 minims to 7.0 minims and has a volumetric capacity of between approximately 0.308-0.431 cc. Other sizes may be used and this disclosure covers the entire range of sizes numbered 1-20 which have dimensions ranging from 0.75 minims to 20 minims. Custom molds could create additional sizes or shapes.

Optionally, the softgel capsule can also be flavored using the flavors listed above in the dietary supplement section.

Softgel color. The softgel capsule in certain embodiments is colored with an iridescent, mineral pigment. A variety of colors of these pigments exist, but each produces an iridescent hue. The preferred color is a pearl-colored, iridescent, mineral pigment. Color selection may vary by contents in the capsules or targeted consumer preferences (see Examples). Preferably, the mineral pigment will be of pharmaceutical grade and have GRAS status. Mineral pigments, such as but not limited to a natural silicate (mica) combined with titanium dioxide and/or iron oxide, or calcium carbonate, can be used to color the softgel capsules of the invention. As used herein, “mica” can include any of several silicates of varying chemical composition (e.g., potassium aluminum silicate), but having similar properties and crystalline structure. All characteristically cleave into thin sheets that are flexible and elastic. Synthetic mica is also available and contemplated for use.

An example of a mica and titanium based mineral pigment suitable for use in the invention is CANDURIN® Pearl Effect Color (Merck KGaA, Darmstadt, Germany). Altogether 15 CANDURIN® pigments are available in four different color groups (silver-white, interference colors, gold, as well as diverse shades of red, brown and orange based on iron oxide). In these pigments, the metal salts such as titanium dioxide are deposited on mica as substrate, and subjected to calcinations at high temperature to afford the pearlescent pigment.

Manufacturing. The round softgels may be made according to standard protocols. Basically a shell material, typically gelatin, is heated and fed through rollers to cool and to create flat sheets. These sheets are then passed over a cylindrical mold, where they partially solidify and then are injected to fill in a round mold. A roller then passes over the mold, punching out the round softgels. This is customary for capsule manufacturing of omega-3-rich oils.

Various gelatin shells can be prepared, depending on the fill properties, climatic conditions, and end use. Typically gelatin compositions include the same basic ingredients, namely, gelatin, a plasticizer such as glycerin, water, and optionally preservatives. The gelatin composition can also include sorbitol. Colorants as are known in the art can be included. The formulations of gelatins are well known to those of ordinary skill in the art.

Shell formulations are discussed in Van Hostetler and J. Q. Bellard noted below as well as in “Advances in Softgel Formulation Technology”, M. S. Patel, F. S. S. Morton and H. Seager, Manufacturing Chemists, July 1989; “Soft Elastic Gelatin Capsules: A Unique Dosage Form”, William R. Ebert, Pharmaceutical Technology, October 1977; “Soft gelatin capsules: a solution to many tableting problems”, H. Seager, Pharmaceutical Technology, September 1985; U.S. Pat. No. 4,067,960 to Fadda; U.S. Pat. No. 4,198,391 to Grainger; U.S. Pat. No. 4,744,988 to Brox; and U.S. Pat. No. 4,780,316 to Brox; U.S. Pat. No. 5,200,191 to Dietel et al. (and references cited therein). Each reference is incorporated by reference in its entirety.

The most common modern manufacturing process involved in the preparation of softgels is a continuous method whereby two gelatin ribbons pass between twin rotating dies. As the ribbons meet, the liquid to be encapsulated is precisely injected between them by injection means as known to those of ordinary skill in the art. The capsule halves are sealed and ejected by the continuous rotation of the dies. See P. Tyle, ed. Specialized Drug Delivery Systems, (New York: Marcel Dekker, Inc., 1990) for a general discussion of softgel manufacturing and production technology, in particular, Chapter 10 by Paul K. Wilkinson and Foo Song Hom.

The iridescent, mineral pigment is either added as a powder during the blending of the shell material, or added as a coating afterwards, either by spraying or immersion.

Pearlized soft gel shell coloring. It is noted that that the term “pearl” or “pearls,” as used herein, is intended to mean a spheroidal softgel capsules having the iridescent and/or pearlescent color features described in the Examples.

The introduction of an iridescent or pearlescent pigment into the gelatin blend prior to shell formation is a unique feature as described herein.

When using previously known procedures, the materials added to a gelatin shell, in addition to providing a shell color, will create either an opaque or translucent shell. In addition these materials are typically soluble in the gelatin blend used to create the shell color. The typical procedure for producing a new color soft gel is as follows.

1. A target color is described either by a sample, color chip or reference to a PMS color. The Pantone® Matching System (PMS) is an industry standard color matching system. The Pantone® color formula guide provides an accurate method for selecting, specifying, broadcasting, and matching colors through any medium.

2. Shell material swatches with varying amounts of colorant(s) are produced in a lab.

3. These swatches are reviewed and the final shell color and formula selected.

The ingredients used to create the pearlescent effect of the described embodiments of the softgels are a composite of mica and titanium dioxide. The presence of titanium dioxide would tend to lead to an opaque soft gel. The resulting color effect of this composite is dependent upon the plating/bonding of the titanium dioxide to the mica. As the plating thickness is increased the perceived color changes form white (silver) to gold, red, blue, and then green. Standardized plating ratios of the titanium dioxide are used to ensure repeatability of the desired color. This pearlescent phenomenon is a result of the thickness of the plate and the refractive and reflective qualities of the mica.

For the present embodiments, it is noted that the following composite blends, which combines the mica and titanium dioxide pigment, when blended into the gelatin material does not go into solution but into suspension (mica) thus creating a translucent color effect.

Using the color selection and matching principles discussed above, once a shell color is approved and a product is put into production, the following steps are followed to produce the shell material.

The basic ratio of ingredients in the shell, other than colorant is:

Gelatin=100 parts

Glycerin=40 parts

Water=72 parts

Colorant(s) based on color formula selected as above added to shell blend. Useful colorants include an iridescent mica-based pigment.

Next, this blend is blended at a temperature of 70-75° C. for 20-30 minutes. In an alternative embodiment, the blend time is about 20 minutes to about 25 minutes. In another embodiment, the blend time is about 25 minutes to about 30 minutes.

When the iridescent pigment, which combines the mica and titanium dioxide, is blended into the gelatin material it does not go into solution but into suspension (as mica) thus creating a translucent color effect.

Prior to first encapsulation of a new product, the following three steps are normally followed:

1. Colored gelatin shell, prepared as above, is compared to a retained approved color swatch.

2. Encapsulation is started using a clear (generally colorless) mineral oil to fill the softgel. (This step may also be used to set a variety of machine settings for production using standard techniques.) Color checked against approved color swatch.

3. Encapsulation using the actual ingredients is begun. (For the present disclosure, a dietary supplement is shown in Example 2A and 2B). Color again checked against approved color swatch.

After many experiments (see Examples), it was determined that the observed (i.e., perceived) color of the softgel was based on a combination of colorants, the iridescent mica-based composite in the shell material and the color of the fill material. This was caused by both the translucence of the shell and the refractive and reflective quality of the gelatinized shell composition containing iridescent mica-based mineral pigment. Light hitting the soft gel is refracted to the observer (i.e., human eye) and gives the appearance of a combination of colors present in the fill and soft gel materials.

The coating/spraying procedure discussed above is a standard procedure for using these sorts of pigments. Any color may be used. In one embodiment, the mineral pigment is applied by spraying a thin and transparent coating film on the surface of the finished products, while turning in a pan. This method results in very uniform and shiny pearl effects. The mineral pigment can be adhered to the softgel by using a binder such as using a transparent cellulosic-(HPMC) or starch-based binder. If a binder is used, the mineral pigment can be first mixed within a liquid suspension containing the transparent binder and then applied via spraying on the surface of the finished products.

The methods described above may be further understood in connection with the following Examples.

### Example 1A

Desired pearlescent shell color: white.

Internal ingredient (fill) color: clear to slight yellow liquid.

Gelatin=100 parts

Glycerin=40 parts

Water=72 parts

The gelatin, glycerin, and water were combined to provide a gelatin pre-mix. Silver (white) composite mica/titanium dioxide (with no added colorant) was added at a level of 2.5% by weight of gelatin pre-mix mass.

Initial lab test was started with 2.0% silver composite based on weight of gelatin pre-mix resulted in a grey shell color. The iridescent mica-based composite weight % was increased till “sharp” white color achieved. Finished color was determined by presenting samples to potential users (a panel of 4 people) who then voted for the “correct” color, that is, a color match suitable for the target product softgel. This formula was then used in the gelatin preparation described above.

Next, this blend was blended at a temperature of 70-75° C. for 20-30 minutes and was gelatinized to produce an iridescent gelatin shell material. The iridescent gelatin shell was filled as above and presented to the panel for approval. The panel determined a color match suitable for the target product softgel.

### Example 1B

Desired pearlescent shell color: gold.

Internal ingredient (fill) color: orange/terra cotta paste ingredient.

Gelatin=100 parts

Glycerin=40 parts

Water=72 parts

The gelatin, glycerin, and water were combined to provide a gelatin pre-mix. Gold composite mica/titanium dioxide was added at a level of 2.5% by weight, with 0.005% FD&C Yellow #5, and 0.0025% FD&C Yellow #6, weights based on gelatin pre-mix mass.

Initial test was started with silver composite and FD&C Yellow #5. However, the initial color was pale. A switch was made to gold composite and FD&C colors were added until the correct color was achieved, based on panel review as in Example 1A. This formula was then used to prepare the gelatin. The three steps prior to and leading to encapsulation were followed with successful results.

Next, this blend was blended at a temperature of 70-75° C. for 20-30 minutes and was gelatinized to produce an iridescent gelatin shell material. The iridescent gelatin shell was filled as above and presented to the panel for approval. The panel determined a color match suitable for the target product softgel.

### Example 1C

Desired pearlescent shell color: pink.

Internal ingredient (fill) color: orange/terra cotta paste ingredient.

Gelatin=100 parts

Glycerin=40 parts

Water=72 parts

The gelatin, glycerin, and water were combined to provide a gelatin pre-mix. Red composite mica/titanium dioxide was added at a level of 2.5% by weight, with 0.0015% FD&C red, weights based on gelatin pre-mix mass.

Initial lab tests were started with silver composite and FD & C Red, and the shell color was accepted. The third step in the encapsulation sequence (encapsulation/filling with actual ingredient) resulted in a perceived lavender color shell (based on panel observations as in Example 1A). The lab procedure was then modified to include a final step where a lab swatch was manually formed to simulate a soft gel shape and the actual fill ingredients added to check perceived color. After several lab tests with the silver composite colorant and varied other colorants, a switch was made to red composite colorant and tested with varying amounts of FD&C red. If the additional colorant level rose above 0.0015% FD &C red color, the shell color was too deep.

After the correct color was achieved, based on panel review as in Example 1A, the formula was then used to prepare the gelatin. The three steps prior to and leading to encapsulation were followed with successful results.

Next, this blend was blended at a temperature of 70-75° C. for 20-30 minutes and was gelatinized to produce an iridescent gelatin shell material. The iridescent gelatin shell was filled as above and presented to the panel for approval. The panel determined a color match suitable for the target product softgel.

As shown in Examples 1A to 1C, by combining various colorants and the form of the mica/titanium dioxide ingredient we are able to produce a softgel with the desired color that the consumer sees. This combination is not standard and will vary with the change of ingredient color. Example 1C above is the most striking example of the effect of refraction caused by the translucent shell and the color of the ingredient blend.

It is further expected that refraction measurements (e.g., refractive index) and/or reflectance data (e.g., reflectance spectra) will demonstrate the desirable unique properties of the iridescent mica-based pigment-containing softgel capsules as described herein.

### Example 2A

Fish Oil Pearls. In accordance with the softgel capsule (“SGC”) preparation procedure described above, the following gelatin shell was prepared, followed by filling/encapsulation to provide an iridescent softgel capsule. Target pearlescent white color was acceptable as discussed above. Actual fill weight: 419.03 mg/softgel. Target dried shell weight: 130 mg. Die roll: 7 round ST.

The shell formula was prepared as described in Table 2.

TABLE 2

| | | | Dry comp. | |
|---|---|---|---|---|
| Ingredient | Specification | Wet comp % | (mg/SGC) | Dry comp. % |
| Beef gelatin | Current USP | 44.000 | 83.930 | 64.561% |
| Glycerin | Current USP | 17.000 | 32.427 | 24.944% |
| Candurin Silver | Current USP | 1.700 | 3.243 | 2.494% |
| lustre 120602 | | | | |
| Purified water | Current USP | 37.300 | 10.400 | 8.000% |
| | Total: | 100.0 | 130.0 | 100.0 |

The fill formula was prepared as described in Table 3.

TABLE 3

| | | Raw | Label | | Input | |
|---|---|---|---|---|---|---|
| | | Mtl. | claim | | Qty. | |
| Ingredients | Specification | Supplier | (mg/SGC | Overage % | (mg/SGC) | Composition % |
| Pollock/whiting* | Current USP | Lang | 400.00 | 4.00% | 416.00 | 99.277 |
| Oil | | PNI** | | | | |
| Natural | Current USP | Lang | 3.00 | 1.00% | 3.03 | 0.723 |
| peppermint oil | | PNI | | | | |
| | | Total | 403.000 | | 419.030 | 100.00 |

*Walleye Pollock and/or N. Pacific Whiting oil
**Lang Pharma Nutrition (Newport, Rhode Island)

### Example 2B

Fish Oil Pearls. Example 2A is repeated using a Wild Alaskan Pollock oil, salmon oil mixture. Target color is acceptable as discussed above.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

The use of the terms “a,” “an,” “the,” and similar referents in the context of describing the presently claimed invention (especially in the context of the claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. Methods may be varied or modified as needed to make the products as described herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

I claim:

1. A softgel capsule having an iridescent appearance, comprising:
a shell for housing one or more dietary supplements, the shell comprised of a gelatinized gelatin and an iridescent mineral pigment that imparts an iridescent appearance to the shell; and
one or more dietary supplements contained within the iridescent shell.

2. The softgel of claim 1, wherein the iridescent mineral pigment is incorporated into the gelatin prior to gelatinization.

3. The softgel of claim 2, wherein the iridescent mineral pigment is present in an amount of about 1.5% by weight to about 2.5% by weight based on the total weight of the shell.

4. The softgel of claim 1, wherein the iridescent appearance is selected from the group consisting of white, silver, gold, pink, red, blue, and green.

5. The softgel of claim 1, wherein the iridescent mineral pigment is coated on the surface of the shell.

6. The softgel of claim 1, wherein the one or more dietary supplements are selected from the group consisting of thiamine, thiamine mononitrate, riboflavin, nicotinic acid, panthothenic acid, pyridoxine, vitamin B6, pyridoxine HCl, biotin, folic acid, vitamin B12, cyanocobalamin, lipoic acid, ascorbic acid, vitamin A, vitamin C, vitamin D, cholecalciferol, vitamin E, di-alpha tocopheryl acetate, vitamin K, phytonadione, niacin, niacinamide, vitamin B5, d-calcium pantothenate, thiamine pyrophosphates (TPP), flavin mononucleotide (FMM), flavin adenine dinucleotide (FAD), nicotinamide adenine dinucleotide (NAD), nicotinamide adenine dinucleotide phosphate (NADP), Coenzyme A (CoA), pyridoxal phosphate, biocytin, tetrahydrofolic acid, coenzyme B12, lipoyllysine, 11-cis-retinal, 1,25-dihydroxycholecalciferol, choline, carnitine, alpha-carotene, beta-carotene, gamma-carotene, calcium, iron, zinc, selenium, copper, iodine, magnesium, phosphorus, chromium, manganese, potassium, boron, molybdenum, pomegranate, acai, grape, plum, cranberry, blueberry, strawberry, blackberry, bilberry, cherry, apricot, papaya, orange, pineapple, parsley, kale, spinach, wheat grass, brussel sprouts, asparagus, broccoli, cauliflower, beet, carrot, cabbage, garlic, cinnamon oil, oil of wintergreen, peppermint oil, clove oil, bay oil, anise oil, eucalyptus, thyme oil, cedar leaf oil, oil of nutmeg, oil of sage, lemon oil, orange oil, oil of bitter almonds, cassia oil, menhaden oil, anchovy oil, anchoveta oil, hake oil, salmon oil, tuna oil, pollock oil, whiting oil, cod oil, catfish oil, flounder oil, grouper oil, halibut oil, mahi mahi oil, orange roughy oil, red snapper oil, shark oil, swordfish oil, tilefish oil, king mackerel oil, krill oil, seal oil, borage oil, flax seed oil, evening primrose oil, soybean oil, hemp seed oil, pumpkin seed oil, grape seed oil, germ oil, safflower oil, squalene oil, squalane, sesame seed oil, arachidonic acid, conjugated linoleic acid, rosemary oil, lemon oil, peppermint oil, terrapin oil, pomegranate seed oil, sea buckthorn fruit oil, sunflower oil, chia oil, goji berry oil, sea buckthorn oil, jasmine oil, sweet almond oil, ginger oil, parsley seed oil, orange oil, halibut liver oil, wheat germ oil, aloe vera oil, garlic oil, avocado oil, castor oil, saw palmetto extract oil, olive oil, mineral oil, median chain tryglycerin, lavender oil, phosphatidylipids, rice bran oil, macadamia nut oil, arachis oil, phytosterol, phytotanol, and mixtures thereof.

7. A method of making a softgel capsule having an iridescent appearance, comprising:
(a) incorporating an iridescent mineral pigment into a gelatin composition;
(b) gelatinizing the gelatin composition of step (a) to thereby form an iridescent shell suitable for containing one or more dietary supplements; and
(c) adding the one or more dietary supplements into the iridescent shell to produce a softgel capsule.

8. The method of claim 7, wherein the iridescent mineral pigment is present in an amount of about 1.5% by weight to about 2.5% by weight based on the total weight of the shell.

9. The method of claim 8, wherein the gelatin composition comprises a mixture of about 100 parts by weight gelatin, about 40 parts by weight glycerin, and about 72 parts by weight water.

10. The method of claim 9, wherein the gelatinizing step of step (b) is carried out at a temperature of about 70° C. to about 75° C.

11. The method of claim 9, wherein the gelatinizing step of step (b) is carried out for a time of about 20 minutes to about 30 minutes.

12. A method of making a softgel capsule having an iridescent appearance, comprising:
(a) gelatinizing a gelatin composition to thereby form a shell suitable for containing one or more dietary supplements;
(b) adding the one or more dietary supplements into the shell to produce a softgel capsule; and
(c) coating the softgel capsule with an iridescent mineral pigment to impart an iridescent appearance.

13. The method of claim 12, wherein the gelatin composition comprises a mixture of about 100 parts by weight gelatin, about 40 parts by weight glycerin, and about 72 parts by weight water.

14. The method of claim 13, wherein the coating step of step (c) is carried out by spraying the iridescent mineral pigment.
